(19) United States
(12) Patent Application Publication
(10) Pub. No.: US 2026/0170635 A1
(43) Pub. Date: Jun. 18, 2026

(54) AUTOMATIC CONTOUR EXTRACTION IN AN IMAGE OF A SPECIMEN

(71) Applicant: Applied Materials Israel Ltd., Rehovot (IL)

(72) Inventors: Yorick Emmanuel TROUILLER, Grenoble (FR); Benjamin Christophe Jo VENITUCCI, Claix (FR); Frederic Sebastien ROBERT, Grenoble (FR)

(21) Appl. No.: 18/983,170

(22) Filed: Dec. 16, 2024

(51) Int. Cl. G06T 7/00; G06T 7/12; G06T 7/62; G06V 10/764

(52) U.S. Cl. CPC G06T 7/001; G06T 7/12; G06T 7/62; G06V 10/764; G06T 2207/20021; G06T 2207/30148; G06V 2201/06

(57) ABSTRACT

There are provided systems and methods comprising obtaining data D_{contour} informative of a contour of at least one element of a semiconductor specimen in an image of the specimen, obtaining design data informative of the at least one element, wherein the design data comprises a plurality of corners, determining, in the design data, first areas, wherein each respective first area of the first areas comprises a respective corner of the plurality of corners, and using the first areas and the data D_{contour} to determine a model which fits the contour.

### TECHNICAL FIELD

The presently disclosed subject matter relates, in general, to the field of examination of a specimen, and more specifically, to automating the examination of a specimen.

### BACKGROUND

Current demands for high density and performance associated with ultra large-scale integration of fabricated devices require submicron features, increased transistor and circuit speeds, and improved reliability. Such demands require formation of device features with high precision and uniformity, which, in turn, necessitates careful monitoring of the fabrication process, including automated examination of the devices while they are still in the form of semiconductor wafers.

Examination processes are used at various steps during semiconductor fabrication to measure dimensions of the specimens (metrology), and/or to detect and classify defects on specimens (e.g., Automatic Defect Classification (ADC), Automatic Defect Review (ADR), etc.).

### GENERAL DESCRIPTION

In accordance with certain aspects of the presently disclosed subject matter, there is provided a system comprising one or more processing circuitries configured to obtain data D_{contour} informative of a contour of at least one element of a semiconductor specimen in an image of the specimen, obtain design data informative of the at least one element, wherein the design data comprises a plurality of corners, determine, in the design data, first areas, wherein each respective first area of the first areas comprises a respective corner of the plurality of corners, and use the first areas and the data D_{contour} to determine a model which fits the contour.

In addition to the above features, the system according to this aspect of the presently disclosed subject matter can optionally comprise one or more of features (i) to (xxii) below, in any technically possible combination or permutation:
i. the system is configured to determine second areas corresponding to straight portions of the design data, and use the first areas, the second areas, and the data D_{contour} to determine the model which fits the contour;
ii. the model fits an average component of the contour;
iii. the model is usable to detect a mismatch between the contour and the design data;
iv. the model is usable to determine one or more metrology measurements;
v. the model is usable to correct a manufacturing process of the element (such as by tuning one or more parameters of the manufacturing process of the element);
vi. the system is configured to use the first areas to generate an initial model, in which each of the corner of the plurality of corners is represented by a curved portion;
vii. the initial model further comprises a plurality of straight portions, wherein the system is configured to fit the initial model to the contour, wherein, in said fit, the curved portions of the initial model remain curved, and the straight portions of the initial model remain straight;
viii. the system is configured to, for each given curved portion of the plurality of curved portions, fit said given curved portion with a corresponding curved portion of the contour, thereby obtaining a plurality of fitted curved portions;
ix. the system is configured to connect the fitted curved portions by straight portions in order to obtain the model;
x. the system is configured to determine, in the contour, a plurality of third areas, informative of curved portions of the contour, and fit each given curved portion of the initial model with a given part of the contour located in a given third area of the plurality of third areas;
xi. the system is configured to fit a piecewise polynomial function to the contour, determine curvature along at least part of the piecewise polynomial function, thereby enabling identification of a plurality of third areas informative of curved portions of the contour, and fit each given curved portion of the plurality of curved portions of the initial model with a given part of the contour located in a given third area of the plurality of third areas, thereby enabling generating the model;
xii. for a given straight component of the initial model, the system is configured to perform a fit between the given straight component and a plurality of points of the contour, wherein said fit models the given straight component using an implicit function.
xiii. the system is configured to approximate the initial model by an implicit function, and perform a fit between the implicit function and at least part of the contour of the at least one element, to obtain the model;
xiv. the system is configured to determine a pairing between respective points of a given curved portion of the plurality of curved portions and respective points of a corresponding curved portion of the contour, and use said pairing to fit the given curved portion to the corresponding curved portion of the contour;
xv. the system is configured to divide the initial model into a plurality of components comprising one or more straight components and one or more curved components, pair each given point of a plurality of points of the contour with a given component of the plurality of components, fit a given straight component of the plurality of components, to points of the contour which have been paired with this given straight component, by using an implicit function, and fit a given curved component of the plurality of components, to points of the contour which have been paired with this given curved component;
xvi. fitting the given curved component of the plurality of components, to the points of the contour which have been paired with this given curved component, comprises pairing the points of the contour which have been paired with this given curved component with points of the given curved component, thereby obtaining a plurality of pairs of points, and using the plurality of pairs of points to perform the fitting;
xvii. the contour is modellable by a first component and a second component, wherein the second component has a higher frequency of variation than the first component, wherein the model fits the first component of the contour;
xviii. the contour is modellable by a profile, wherein said profile is correctable in order to improve its match with the design data, wherein the model fits said correctable profile;
xix. the contour is modellable by an additional part which is non-correctable locally, wherein the system is operative to differentiate between the profile and said additional part;
xx. the system is configured to store the model using a format enabling curvilinear representation using Bezier and/or B-spline curves;
xxi. the system is operative to determine the model which fits the contour of the element without requiring prior knowledge on the shape of the contour; and
xxii. the system is operative to determine the model which fits the contour whatever the contour's shape, wherein the contour comprises one or more curved portions.

In accordance with other aspects of the presently disclosed subject matter, there is provided a computer-implemented method comprising obtaining data D_{contour} informative of a contour of at least one element of a semiconductor specimen in an image of the specimen, obtaining design data informative of the at least one element, wherein the design data comprises a plurality of corners, determining, in the design data, first areas, wherein each respective first area of the first areas comprises a respective corner of the plurality of corners, and using the first areas and the data D_{contour} to determine a model which fits the contour.

In addition to the above features, the method can include one or more of features (i) to (xxii) above, in any technically possible combination or permutation.

In accordance with other aspects of the presently disclosed subject matter, there is provided a non-transitory computer readable medium comprising instructions that, when executed by at least one or more processing circuitries, cause the at least one or more processing circuitries to perform: obtaining data D_{contour} informative of a contour of at least one element of a semiconductor specimen in an image of the specimen, obtaining design data informative of the at least one element, wherein the design data comprises a plurality of corners, determining, in the design data, first areas, wherein each respective first area of the first areas comprises a respective corner of the plurality of corners, and using the first areas and the data D_{contour} to determine a model which fits the contour.

In addition to the above features, the non-transitory computer readable medium comprises instructions that, when executed by the one or more processing circuitries, cause the one or more processing circuitries to perform, to implement or to include one or more of features (i) to (xxii) above, in any technically possible combination or permutation.

The proposed solution provides various technical advantages. At least some of them are listed hereinafter.

According to some examples, the proposed solution enables automatic extraction of a contour of an element from an image acquired by an examination tool.

According to some examples, the proposed solution automatically adapts to any kind of pattern or shape of element.

According to some examples, the proposed solution does not require any prior knowledge on the shape of the element.

According to some examples, the proposed solution is operative to perform an automated decomposition between a part of the contour associated with high frequency variations (also called stochastic part, or non-correctable part) and a part of the contour associated with low frequency variations (also called average part, or a correctable part) of the contour of an element, based on an image of the element acquired by the examination tool.

According to some examples, the proposed solution enables storing different models informative of the evolution of the contour of an element over time, thereby enabling tracing the evolution of the contour depending on the evolution of the manufacturing process.

According to some examples, the proposed solution enables correcting knobs of the manufacturing process at an early stage.

According to some examples, the proposed solution enables accurate metrology operations.

According to some examples, the proposed solution enables quality monitoring.

According to some examples, the proposed solution enables accurate patterning control.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a generalized block diagram of an examination system in accordance with certain examples of the presently disclosed subject matter.

FIG. 2 illustrates a generalized flow-chart of a method of determining a model informative of the contour of an element of a specimen.

FIG. 3 illustrates a contour of a specimen, and an initial model generated based on design data.

FIG. 4 illustrates an identification of corners in the design data informative of an element.

FIG. 5 illustrates curved portions used to generate an initial model.

FIG. 6 illustrates a split of an initial model into curved portions and straight portions.

FIG. 7 illustrates a generalized flow-chart of a method which performs piecewise fitting between an initial model and the contour.

FIG. 8 illustrates a non-limitative example of the method of FIG. 7.

FIGS. 9 and 10 illustrate a pairing process between the initial model and the contour.

FIG. 11 illustrates curved portions of the initial model after the fitting process.

FIG. 12A illustrates the generation of a model based on the curved portions of FIG. 11, which approximates the contour of the element.

FIG. 12B is a generalized flow-chart of a method of estimating the high-frequency component of a contour of an element.

FIG. 12C illustrates the modelling of the contour of the element by two components.

FIG. 12D illustrates a zoom of certain parts of FIG. 12C.

FIG. 13 is a generalized flow-chart of a method of estimating the curved portions of a contour of an element, in order to generate a model informative of the contour.

FIGS. 14 to 17 illustrate non-limitative examples of the method of FIG. 13.

FIG. 18A illustrates a generalized flow-chart of another method of determining a model informative of the contour of an element of a specimen.

FIG. 18B illustrates a generalized flow-chart of another method of determining a model informative of the contour of an element of a specimen.

FIG. 18C illustrates an example of a pairing process, which is usable e.g., in the method of FIG. 18B.

FIG. 18D illustrates a pairing and fitting process, which is usable e.g., in the method of FIG. 18B.

FIG. 18E illustrates a non-limitative example of the method of FIG. 18D.

FIG. 19 illustrates a generalized flow-chart of a method of storing different models informative of the evolution of the contour of an element.

FIG. 20 illustrates a generalized flow-chart of a method of determining a model informative of the contour of an element of a specimen, which adapts to any shape of the contour of a specimen.

### DETAILED DESCRIPTION OF EMBODIMENTS

A semiconductor specimen includes various elements. Manufacturing of each element is performed according to a design intent (design data). Differences exist between an element as manufactured, and the design intent. It is intended to detect these differences.

The contour of the element as manufactured can be modelled by two components: a correctable part (associated with low frequency variations) and a non-correctable part (associated with high frequency variations). The correctable part corresponds to the part of the contour for which a tuning of the manufacturing process enables improving its match with the design intent (design data). The non-correctable part corresponds to high frequency variations (also called stochastic variations) of the contour, which cannot be corrected or removed locally by tuning the manufacturing process of the element.

The proposed solution automatically decomposes the contour of an element in an image thereof into the correctable part and the non-correctable part. The correctable part (and, if necessary, the non-correctable/stochastic part) can be output to the manufacturer. A possible usage of this correctable part is to improve the manufacturing process of the element.

According to some examples of the proposed solution, the contour of an element is extracted from an image acquired by an examination tool (e.g., SEM). Design data (CAD data) informative of the specimen is obtained. The design data includes straight lines modelling the contour of the element. Areas of the design data corresponding to corners are identified. An initial model is generated, in which each of the areas is approximated by a curved portion. The other portions of the initial model are approximated by straight portions. A fit between each curved portion of the initial model, and a corresponding curved portion of the contour, is performed. After this fit, the curved portions are joined using straight portions. A model is obtained, which is informative of the correctable part of the contour of the element. A comparison between this model and the design intent enables the manufacturer to understand the mismatch between the correctable part of the contour and the design intent. This enables the manufacturer to correct one or more parameters (also called knobs) of the manufacturing process, in order to improve a match between the contour as manufactured and the design data. The output of the solution(s) described herein can be used for various applications, such as (but not limited to): metrology measurements (e.g., Critical Dimension measurements), determination of edge placement error, stochastic metrology, monitoring of the contour over time for quality insurance purpose, separation between the correctable part and the non-correctable part of the element, patterning control, improvement of the manufacturing process, etc.

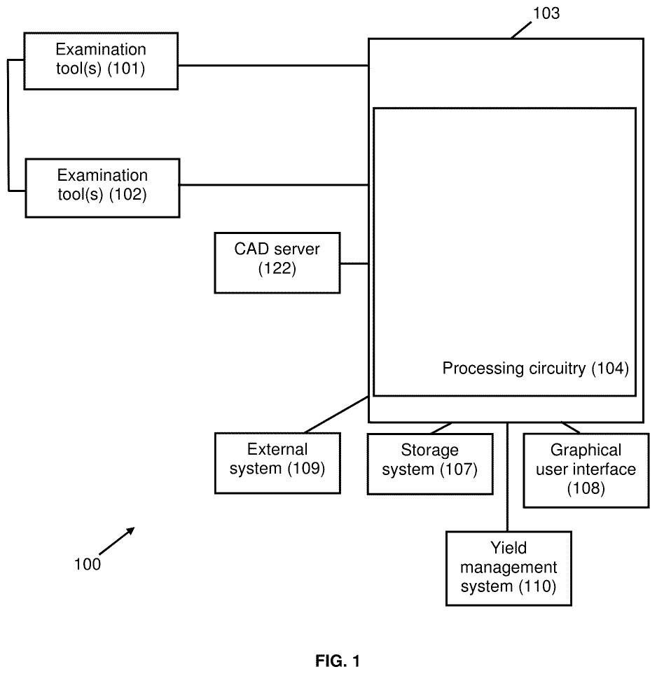

Attention is drawn to FIG. 1 illustrating a functional block diagram of an examination system 100 in accordance with certain examples of the presently disclosed subject matter. The examination system 100 illustrated in FIG. 1 can be used for examination of a specimen (e.g., of a wafer and/or parts thereof) as part of the specimen fabrication process. The illustrated examination system 100 comprises computer-based system 103 capable of automatically determining metrology information and/or defect-related information using images obtained during specimen fabrication. System 103 can be operatively connected to one or more examination tools 101, 102. The examination tools are configured to capture images and/or to review the captured image(s) and/or to enable or provide measurements related to the captured image(s). In some examples, the examination tool(s) can correspond to one or more inspection tool(s) 101 and the examination tool(s) can correspond to one or more review tool(s) 102.

The examination tool(s) 101, 102 can include at least one of: an electron beam examination tool (such as a SEM), an optical examination tool (such as, but not limited to, the Enlight™ tool of the Applicant), an Atomic Force Microscopy (AFM), etc. In some cases, the same examination tool can provide low-resolution image data and high-resolution image data. In some cases, at least one examination tool can have metrology capabilities.

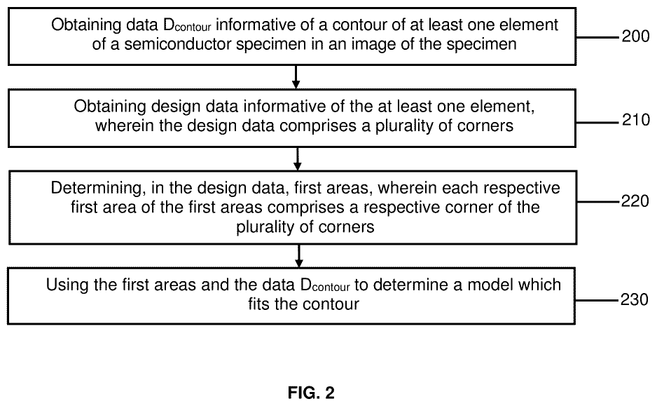

System 103 includes a processing circuitry 104, which includes one or more processors and one or more memories. The processing circuitry 104 is configured to provide all processing necessary for operating the system 103, as further detailed hereinafter (see methods described in FIGS. 2, 7, 10, 12B, 13, 18A, 18B, 18D, 19 and 20 which can be performed at least partially by system 103 and/or system 100).

System 103 is configured to receive input data. Input data can include data (and/or derivatives thereof and/or metadata associated therewith) produced by the examination tools 101, 102, and/or data generated based on the output of the examination tools. It is noted that input data can include at least one of: images (e.g., captured images, images derived from the captured images, simulated images, synthetic images, etc.), associated numeric data (e.g., metadata, hand-crafted attributes, etc.). It is further noted that image data can include data related to a layer of interest and/or to one or more other layers of the specimen. It is noted that image data can be received and processed together with metadata (e.g., pixel size, text description of defect type, parameters of image capturing process, etc.) associated therewith.

System 103 is operatively connected to a CAD server 122, which stores design data (also called CAD data) of one or more specimens, and/or of one or more fleets of specimens. A fleet of specimens corresponds to specimens manufactured using the same manufacturing process.

System 103 can send instructions to any of the examination tool(s) 101, 102, store the results in a storage system 107, and render the results via a computer-based graphical user interface GUI 108, and/or to an external system 109 and/or to a yield management system (YMS) 110. A yield management system (YMS) is a data management, analysis, and tool system that collects data from the fab, especially during manufacturing ramp-ups, in order to improve yield.

Those versed in the art will readily appreciate that the teachings of the presently disclosed subject matter are not bound by the system illustrated in FIG. 1: equivalent and/or modified functionality can be consolidated or divided in another manner and can be implemented in any appropriate combination of software with firmware and/or hardware.

It is noted that the examination system illustrated in FIG. 1 can be implemented in a distributed computing environment, in which the aforementioned functional modules shown in FIG. 1 can be distributed over several local and/or remote devices, and can be linked through a communication network. It is further noted that in some embodiments at least some of the examination tools 101 and/or 102, storage system 107, CAD server 122, external system 109, GUI 108, YMS 110 can be external to the examination system 100 and operate in data communication with system 103. System 103 can be implemented as stand-alone computer(s) to be used in conjunction with the examination tools. Alternatively, the respective functions of the system can, at least partly, be integrated with one or more examination tools.

Attention is now drawn to FIG. 2.

Assume that an image of at least one element of a specimen has been obtained. The element can correspond to any feature (or part of a feature) present in the specimen, such as a gate, a contact, a hole, an electrical line, etc. These examples are not limitative. In some examples, the image can include multiple features. The image may have been acquired by an examination tool (see references 101, 102 in FIG. 1), such as, but not limited to, a SEM.

The method of FIG. 2 includes obtaining (operation 200) data D_{contour} informative of a contour of at least one element of a semiconductor specimen in the image of the specimen. The data D_{contour} can include an area of the image which includes the contour of the element. This area is extracted from the image. The data D_{contour} can also include a set of points which belong to the contour of the element. Extraction of the contour from the image can rely on the usage of algorithms such as segmentation algorithms, image processing algorithms, edge detection algorithms, machine learning algorithms (including artificial intelligence algorithms), etc.

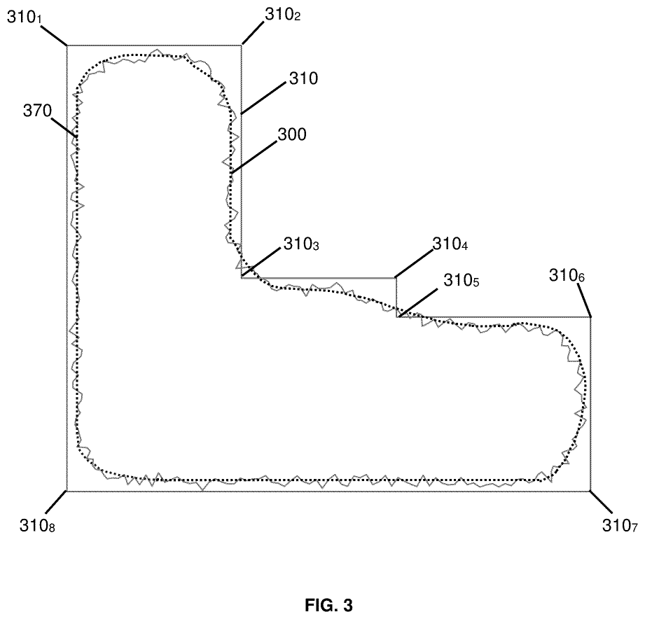

A non-limitative example of a contour 300 of an element, as extracted from an image of the element, is illustrated in FIG. 3. As visible in FIG. 3, high frequency variations are present (corresponding to the stochastic/non-correctable part of the contour). These high frequency variations are present around a profile 370 of the contour, which can be viewed as the average profile of the contour. This profile corresponds to variations of the contour with lower frequencies. It can be viewed as the average position of the points of the contour.

The method of FIG. 2 further includes obtaining (operation 210) design data informative of the element. The design data can correspond to CAD data. The design data generally includes a plurality of interconnected lines (e.g., straight lines) describing the contour of the element. The design data is usually represented by polygons with OASIS format (Manhattan shapes). This is however not limitative. A non-limitative example of design data informative of the element with the contour 300, is illustrated in FIG. 3 (see reference 310).

The design data includes a plurality of corners (see for example references 310₁, . . . , 310₇ in FIG. 3). In some examples, a corner corresponds to an area of the design data in which there is an angle of 90 degrees between two connected straight lines of the design data. Note that it is possible that the corner has a different angle, e.g., 45 degrees, or any other angle which is not 0 (or 180 degrees).

The method of FIG. 2 includes determining (operation 220), in the design data, first areas. Each respective first area of the first areas comprises a respective corner of the plurality of corners. Detection of a corner can be performed by determining the angle between two connected lines of the design data. A corner is detected when the angle is equal to, or above a given threshold (e.g., 90 degrees, or other values different from zero). Each of the first areas can include a different corner of the design data or can correspond to a different corner of the design data.

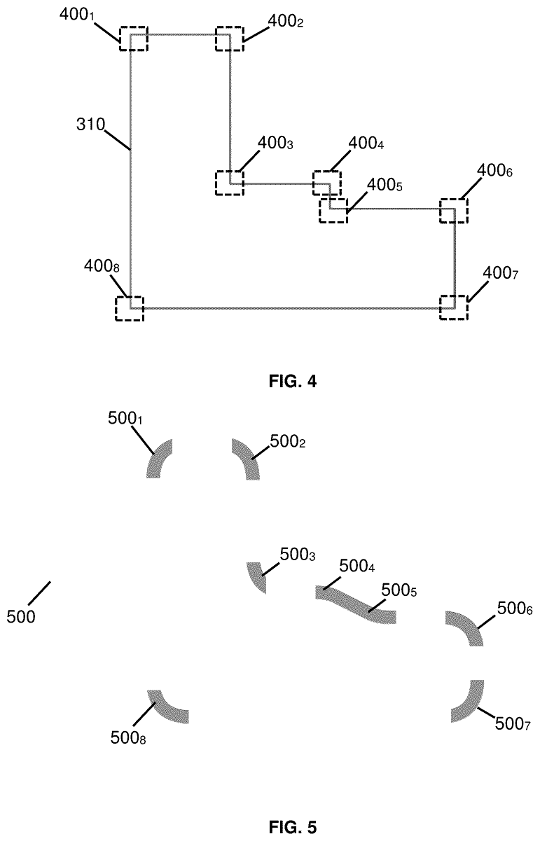

A non-limitative example is illustrated in FIG. 4, in which the first areas 400₁ to 400₈ are identified in the design data. Each given first area 400ᵢ (with i from 1 to 8 in this example) includes a different corner 310i of the design data 310.

The method of FIG. 2 further includes using (operation 230) the first areas and the data D_{contour} to determine a model which fits the contour.

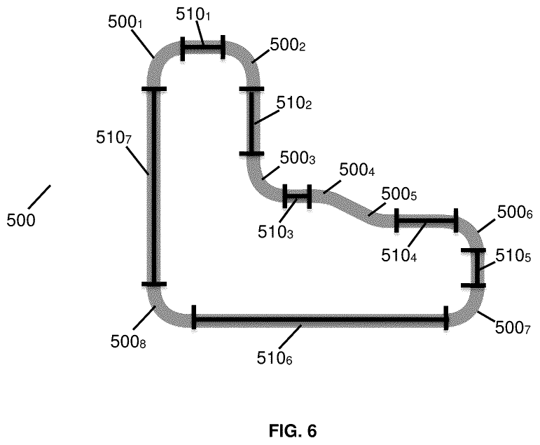

In particular, identification of the first areas enables generating an initial model (see reference 500 in FIG. 6). In this initial model, each corner of the plurality of corners of the design data is represented by a curved portion (as recited in operation 700). The location of each curved portion in the initial model is determined based on the first areas. Each given first area (identified in the design data) is represented in the initial model by a curved portion, which represents a corresponding corner of the design data. A non-limitative example is illustrated in FIG. 5. In this example:
the corner 310₁ (located in the first area 400₁) of the design data 310 is represented by the curved portion 500₁ in the initial model;
the corner 310₂ (located in the first area 400₂) of the design data 310 is represented by the curved portion 500₂ in the initial model;
the corner 310₃ (located in the first area 400₃) of the design data 310 is represented by the curved portion 500₃ in the initial model;
the corner 310₄ (located in the first area 400₄) of the design data 310 is represented by the curved portion 5004 in the initial model;
the corner 310₅ (located in the first area 400₅) of the design data 310 is represented by the curved portion 500₅ in the initial model;
the corner 310₆ (located in the first area 400₆) of the design data 310 is represented by the curved portion 500₆ in the initial model;
the corner 310₇ (located in the first area 400₇) of the design data 310 is represented by the curved portion 500₇ in the initial model; and
the corner 310₈ (located in the first area 400₈) of the design data 310 is represented by the curved portion 500₈ in the initial model.

The curvature of each curved portion in the initial model can be selected randomly. In some examples, data provided by the manufacturer can be used. Indeed, the manufacturer has some knowledge on the approximate curvature at each location along the contour, based on his knowledge of the manufacturing process. Therefore, this can be used to select an initial value for the curvature of each curved portion of the initial model. This is however not mandatory, and it is not required to have prior knowledge of the local curvature along the contour.

The curved portions (see FIGS. 5 and 6) are then connected by straight portions in order to generate the initial model. In particular, adjacent curved portions of the initial model are connected by straight portions. Note that it can occur that adjacent curved portions which are close one to the other are represented by a continuous curved portion. In the non-limitative example of FIGS. 5 and 6:
the curved portion 500₁ is connected to the curved portion 500₂ by a straight portion 510₁;
the curved portion 500₃ is connected to the curved portion 500₄ by a straight portion 510₃;
the curved portion 500₄ and the curved portion 500₅ are fused into a continuous curved portion, due to their proximity;
the curved portion 500₅ is connected to the curved portion 500₆ by a straight portion 510₄;
the curved portion 500₆ is connected to the curved portion 500₇ by a straight portion 510₅;
the curved portion 500₇ is connected to the curved portion 500₈ by a straight portion 510₆; and
the curved portion 500₈ is connected to the curved portion 500₁ by a straight portion 510₇.

A fitting process (operation 710) between the initial model and the contour is then performed.

According to some examples, this fitting is performed piecewise. Each curved portion of the initial model is fit to a corresponding curved portion of the contour. A non-limitative example is illustrated in FIG. 8. In this example:
the curved portion 500₁ of the initial model 500 is fit to the curved portion 800₁ of the contour 800;
the curved portion 500₂ of the initial model 500 is fit to the curved portion 800₂ of the contour 800;
the curved portion 500₃ of the initial model 500 is fit to the curved portion 800₃ of the contour 800;
the curved portion 500₄ of the initial model 500 is fit to the curved portion 800₄ of the contour 800;
the curved portion 500₅ of the initial model 500 is fit to the curved portion 800₅ of the contour 800;
the curved portion 500₆ of the initial model 500 is fit to the curved portion 800₆ of the contour 800;
the curved portion 500₇ of the initial model 500 is fit to the curved portion 800₇ of the contour 800; and
the curved portion 500₈ of the initial model 500 is fit to the curved portion 800₈ of the contour 800.

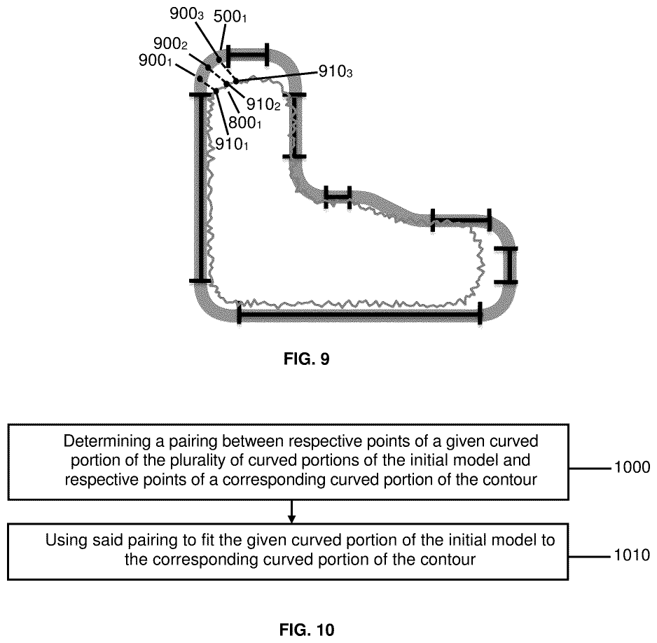

The fitting of the respective curved portions of the initial model with the respective curved portions of the contour can rely on a pairing method, as illustrated in FIGS. 9 and 10.

Assume that a given curved portion (see e.g., 500₁) of the initial model has to be fit to a given curved portion (see e.g., 800₁) of the contour.

For each point of a plurality of points of the given curved portion of the initial model, a corresponding point of the given curved portion of the contour is identified (operation 1000 in FIG. 10). A plurality of pairs of points is obtained. In other words, a pairing between respective points of a given curved portion of the plurality of curved portions and respective points of a corresponding curved portion of the contour is obtained. The pairing can be based on different criteria. In some examples, pairs of points are identified based on the distance between them. Points for which their inter-distance is minimal can be identified as a pair of points. In some examples, pairs of points are identified based on the local curvature. Points with similar local curvatures can be identified as a pair of points. In some examples, both the distance and the local curvature can be taken into account. Points for which their inter-distance is below a threshold, and their local curvature match according to a certain criterion, can be identified as a pair of points.

In the non-limitative example of FIG. 9:
the point 900₁ of the initial model is paired with the point 910₁ of the contour;
the point 900₂ of the initial model is paired with the point 910₂ of the contour; and
the point 900₃ of the initial model is paired with the point 910₃ of the contour.

Once the pairing has been determined, the method of FIG. 10 can include using the pairing (operation 1010) to fit the given curved portion to the corresponding curved portion of the contour. In particular, the fitting can use a cost function which tries to minimize the inter-distance between the different pairs of points (as identified in the pairing process). Note that the fitting can be performed independently for each given curved portion of the initial model: each given curved portion is fit to a corresponding curved portion of the contour.

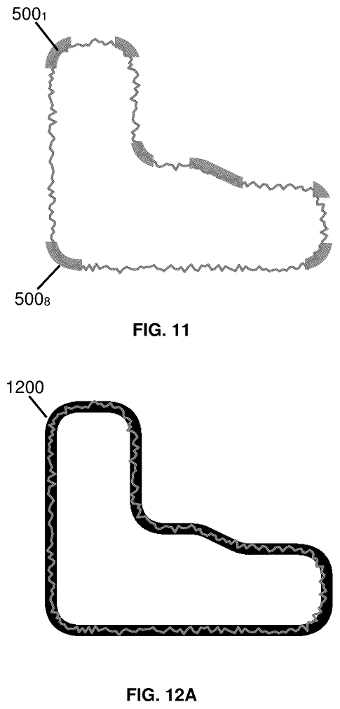

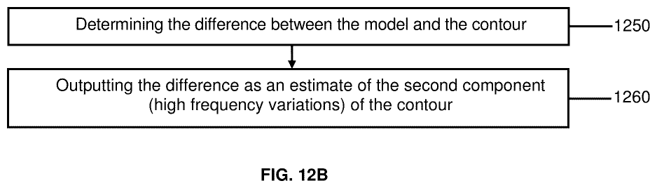

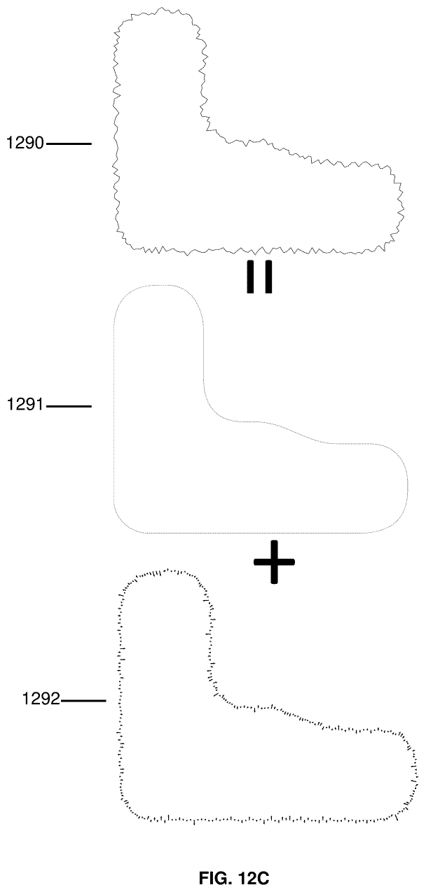

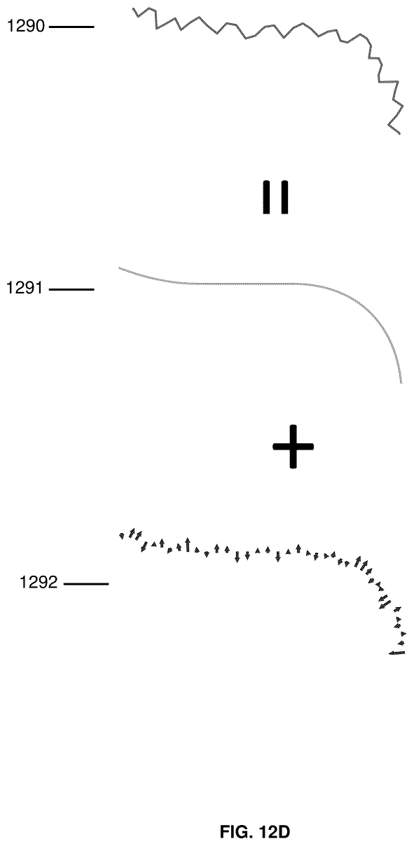

Once the curved portions of the initial model have been fit to the respective curved portions of the contour (as visible in FIG. 11), straight portions are generated to connect the curved portions of the initial model, obtained after this fitting. For example, in FIG. 11, a straight portion is generated to connect the curved portion 500₁ with the curved portion 500₈. This is performed between each curved portion of the initial model and the next curved portion of the initial model. A model 1200 is therefore obtained (see FIG. 12A), which fits the contour. In particular, the points of the contour are spread around an average profile of the contour (see profile 370 in FIG. 3). The model fits the average profile of the contour, which corresponds to the correctable part of the contour.

As can be understood, the initial model is fit to the contour, wherein, in said fit, the curved portions of the initial model remain curved, and the straight portions of the initial model remain straight. In particular, in order to generate the model, the straight portions of the initial model can change size and/or can be translated, but cannot rotate.

As mentioned above, the contour (see 1290 in FIGS. 12C and 12D) can be modelled by two components: a first component (see 1291 in FIGS. 12C and 12D) and a second component (see 1292 in FIGS. 12C and 12D). The second component has a higher frequency of variation than the first component. The model fits the first component of the contour. The first component can be viewed as the average position of the cloud of points along the contour. The second component corresponds to the points which are located outside of this average position.

The first component is the correctable part of the contour. If differences between the design data and the model are identified, this indicates that the correctable part of the contour need to be corrected. Tuning of the manufacturing process enables improving the match between the correctable part and the design data. As a consequence, one or more parameters (also called knobs) of the manufacturing process can be changed in order to modify the first component of the contour. Examples of knobs include temperature, pressure, duration of the manufacturing process, etc. The manufacturer can test different variations in the knobs of the manufacturing process, until the correctable part of the contour matches the desired data (with a difference below a certain threshold depending on the needs and/or the application).

The first component can be used to perform metrology measurements, such as, but not limited to, determination of critical dimension(s) of the element(s) of the specimen. In some examples in which a mismatch in the critical dimension(s) of the element(s) have been identified with respect to the design data, the dose and/or the focus of the scanner (lithography tool) can be modified. This is however not limitative and other parameters can be modified.

In some examples in which an edge placement error (EPE) has been identified, the optical proximity correction with photo-mask re-spin can be adjusted. Optical proximity correction is a solution to correct the systematic EPE deviation observed on the wafer with an examination tool.

The second component (with high frequency variations), also called stochastic part or non-correctable part of the contour, cannot be corrected locally by modifying the manufacturing process. In other words, the average position of the points along the contour can be corrected in order to better match the design data. However, even if parameters of the manufacturing process are tuned, the high frequency variations of the points of the contour (with respect to the desired average position) still remain present. Note that the second component can be used also to perform metrology measurements, such as stochastic metrology measurements. In some examples, the first component and/or the second component can be used to perform various analysis, such as measurement of LER (Line Edge Roughness) in the contour. This is however not limitative.

In some examples, the method (see FIG. 12B) includes determining (operation 1250) the difference between the model and the contour. This difference is an estimate of the second component of the contour. It can be output (operation 1260) e.g., to the manufacturer. A non-limitative example of the second component 1292 is provided in FIGS. 12C and 12D.

The method enables separating between the first component (correctable part) and the second component (non-correctable part—also called stochastic contribution).

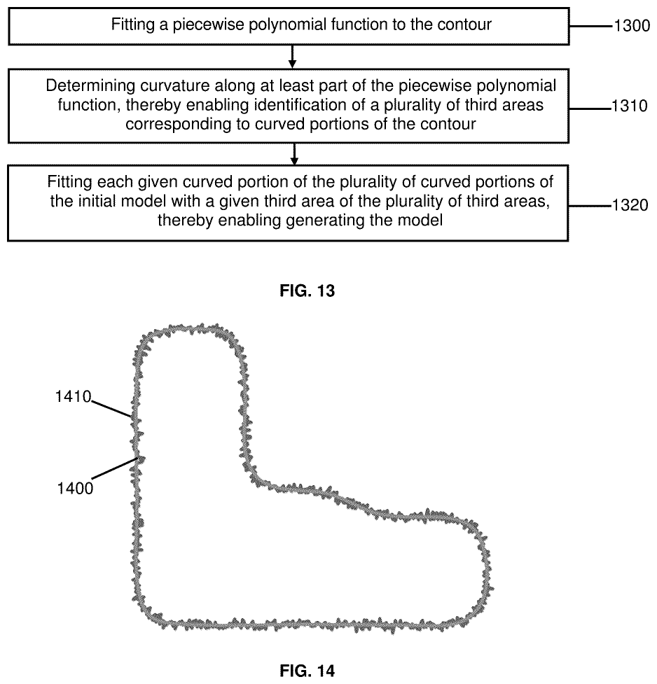

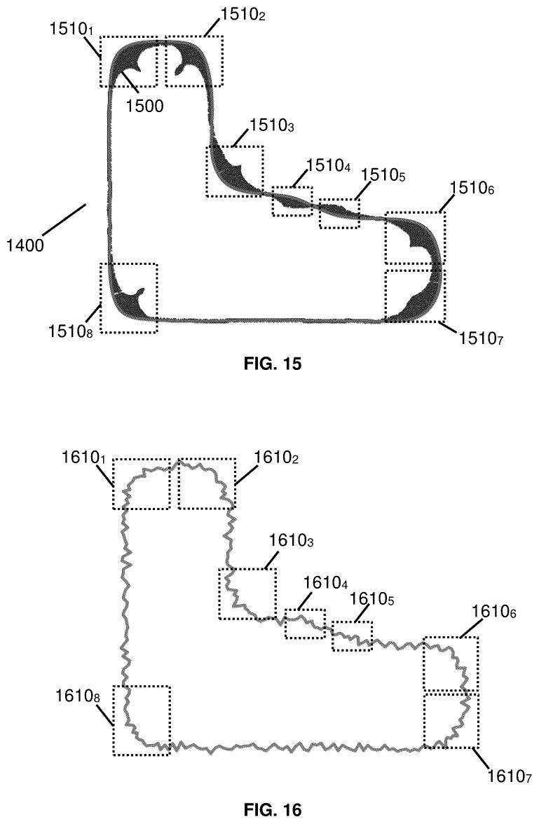

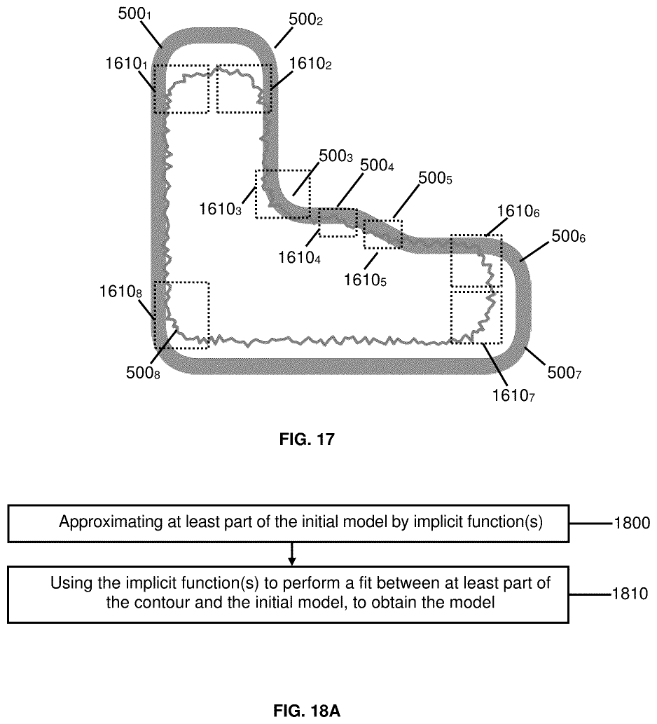

Attention is now drawn to FIGS. 13 to 17.

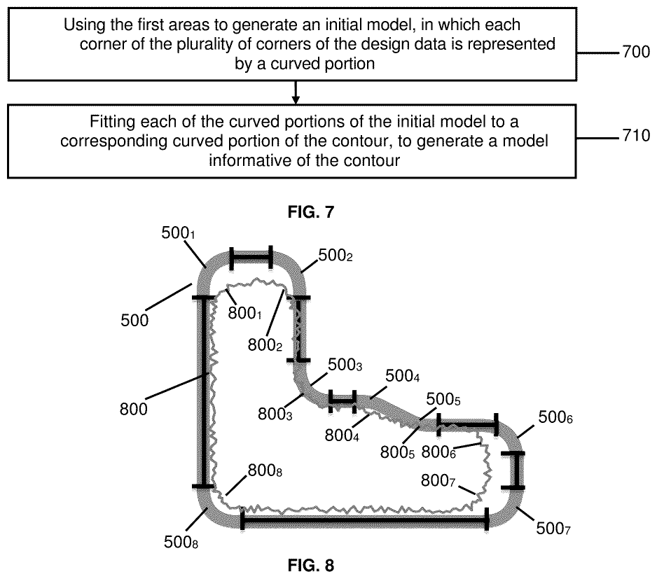

As explained with reference to FIG. 7, each curved portion of the initial model can be fit to a corresponding curved portion of the contour. The method of FIG. 13 enables identifying the location of the curved portions of the contour. As visible in FIG. 3, the contour (see reference 300) is associated with high-frequency variations, rendering the detection of the curved portions of the contour challenging. The method of FIG. 13 enables detecting the location of the curved portions of the contour even in this noisy environment.

The method of FIG. 13 includes fitting (operation 1300) a piecewise polynomial function 1400 to the contour 1410. In some examples, the piecewise polynomial function 1400 corresponds to a B-spline function. This is however not limitative.

The method of FIG. 13 further includes using (operation 1310) the piecewise polynomial function 1400 to determine curvature along at least part of the contour. In particular, the curvature 1500 is determined along the piecewise polynomial function 1400. Determination of the curvature is facilitated in the piecewise polynomial function 1400 since the high-frequency variations of the original contour have been removed. In some examples, since the equation of the piecewise polynomial function 1400 is available, the curvature can be determined based on the equation of this piecewise polynomial function 1400.

The areas 1510₁ to 1510₈ in which the level of curvature is above a threshold (over a certain minimal distance of the piecewise polynomial function 1400) are identified. This enables identification of a plurality of third areas corresponding to curved portions of the contour. Indeed, each area (1510₁ to 1510₈) identified in the piecewise polynomial function 1400 corresponds to a respective third area (1610₁ to 1610₈) in the contour.

The method of FIG. 13 includes fitting (operation 1320) each given curved portion of the plurality of curved portions (500₁ to 500₈) of the initial model with a given curved portion located in a given third area of the plurality of third areas (1610₁ to 1610₈). As already explained above, the plurality of curved portions obtained after this fit are then connected by straight portions. This enables generating the model that fits the average position of the points (average component) of the contour.

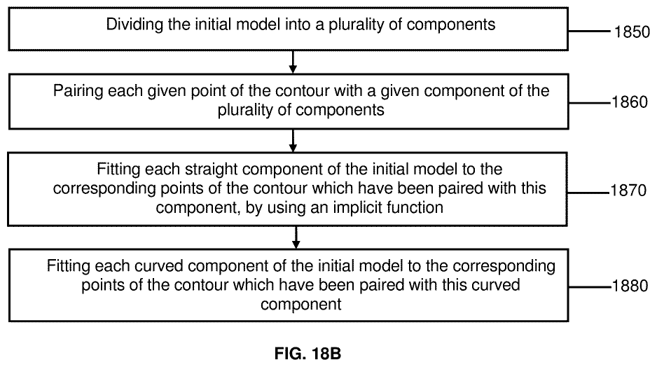

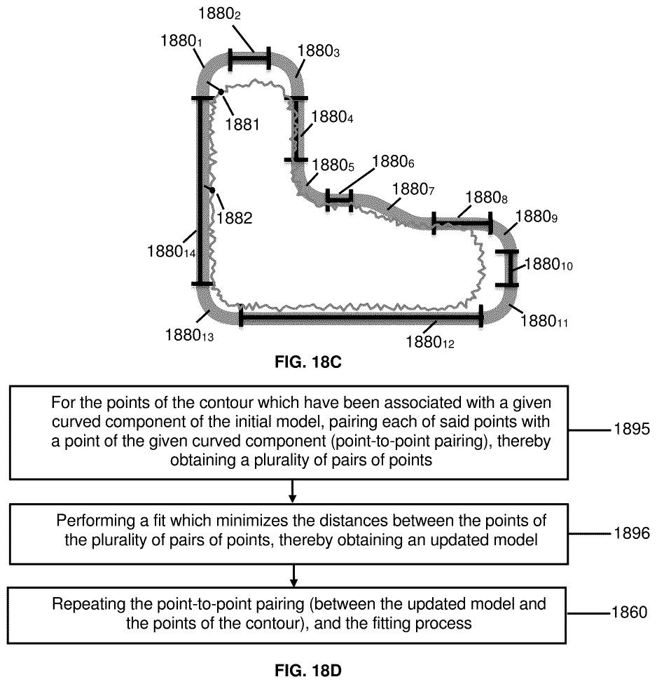

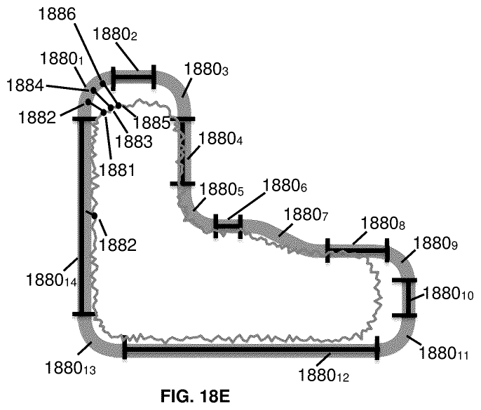

Attention is now drawn to FIG. 18A.

As mentioned with reference to FIG. 7, an initial model is generated. The method of FIG. 18A includes approximating (operation 1800) at least part of the initial model by an implicit function. The implicit function is a relation of the form F(x, y)=0. The function F is generally selected as a polynomial function. The method of FIG. 18A further includes using (operation 1810) the implicit function(s) to perform a fit between at least part of the contour and the initial model, to obtain the model.

In particular, it is possible to approximate each respective straight line (straight component) of the initial model by a respective implicit function. A non-limitative example of an implicit function enabling modelling a straight line can be written: ax+by+c=0. The respective implicit functions can then be used to perform a fit between the initial model and the points of the contour. This fit enables obtaining the model, which corresponds to the estimate of the first component of the contour (average position of the points along the contour).

FIG. 18B depicts a non-limitative example of the implantation of the method of FIG. 18A.

As mentioned above, the initial model (smooth CAD model—see e.g., FIG. 7) can be divided (operation 1850) into different components Cᵢ (with “i” the i^{th} component). In the example of FIG. 18C, the initial model is divided into components 1880₁ to 1880₁₄.

The method of FIG. 18C further includes pairing (operation 1860) each given point of the contour with a given component of the plurality of components. In other words, each point of the contour is associated with a certain component Ci of the initial model. This pairing can include determining, for each given point of the contour, a given component of the initial model which has the shortest distance to this given point. In other words, a pairing between points of the contour and components of the initial model is performed. A non-limitative example is provided in FIG. 18D, in which the point 1881 of the contour is paired to the component 1880₁, and the point 1882 is paired to the component 1880₁₄.

A fit between the initial model and the contour is then performed.

In some examples, for each component (straight component) of the initial model corresponding to a straight line, a fit is performed between the straight component and the points of the contour which have been paired with the straight component.

In some examples, a fit which uses an implicit function can be used (operation 1870). Assume that an implicit function of a straight line is defined as Fᵢ(x, y), for which the parameters of the function need to be determined. A non-limitative example of the implicit function of a straight line is aᵢx+bᵢy+cᵢ=0, with aᵢ, bᵢ and cᵢ the parameters to be determined during the fit. Assume that the points of the contour which have been paired with the contour Cᵢ are noted xᵢ, yᵢ. The fit can include minimizing the cost

$${\sum }_{i} {F}_{i}^{2} ( {x}_{i} , {y}_{i} ) .$$

A least square optimization can be performed. Therefore, each straight line of the initial model undergoes a transformation (e.g., translation, size modification) enabling a better fit with the corresponding part of the contour.

Regarding the components Cᵢ of the contour corresponding to curved parts, the fit can include fitting each curved component of the initial model to the corresponding points of the contour which have been paired with this curved component (operation 1880).

In some examples (see FIG. 18D), for a plurality of points that have been associated with a given curved component of the initial model, this fit can include pairing (operation 1895) each point of this plurality of points with a point of the given curved component. In other words, this pairing is a point-to-point pairing (and not a point to contour pairing as described beforehand). This pairing can include selecting, for each point of the contour, a point from the initial model for which the distance between them is minimal.

A non-limitative example is provided in FIG. 18E, in which the points 1881, 1883 and 1885 of the contour have been paired with the curved component 18801. Point 1881 is paired with point 1882, point 1883 is paired with point 1884 and point 1885 is paired with point 1886.

Then, a fit is performed (operation 1896) in which it is tried to minimize the distances between the different pairs of points (each pair including a point of the contour and a pair of the curved part of the initial model). An updated curved part is obtained. A new pairing process can be performed, in which each point of the contour is paired with a point of the updated curved part. A fit is performed again, in which the distances between the points of the respective pairs of points (each pair including a point of the contour and a pair of the updated curved part of the initial model) is minimized. The process can be repeated iteratively until a criterion is met (such as the distance between the pairs of point is below a threshold). In other words, an iterative pairing process (iterative point-to-point pairing) can be performed.

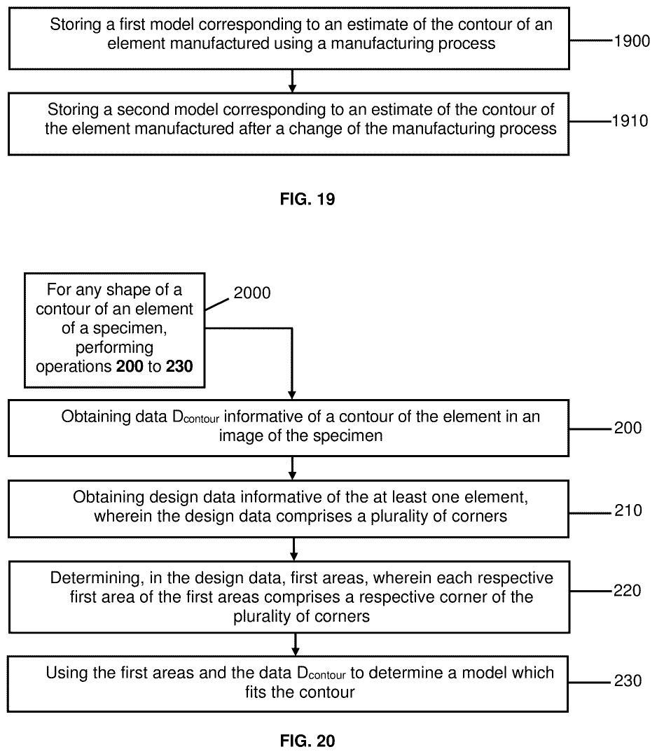

Attention is now drawn to FIG. 19.

Once the model fitting the contour has been determined, it can be stored in a memory, such as a non-transitory memory (operation 1900). In some examples, the model can be stored using a format enabling curvilinear representation. In some examples, the model can be stored using a format enabling both linear representation and curvilinear representation. In some examples, the model can be stored using a format enabling Bézier and/or Bsplines representation. In some examples, the model can be stored using a multigon format. In some examples, the model can be stored using a P49 OASIS standard.

The manufacturer (or any other user) may decide on changing one or more knobs of the manufacturing process, in order to manufacture a new specimen containing the element after tuning of the manufacturing process. A new image of the specimen can be acquired and can be processed according to the various methods described above. A new model, informative of the average component (correctable part) of the contour of the element in the new image, is therefore generated, which can be stored in a memory (operation 1910). The various methods described herein can be used to generate the new model.

Storing the models (informative of the various contours obtained over time) enables comparing the evolution of the contour over time. This enables assessing the impact of changes in the manufacturing process. This enables also quality and/or assurance monitoring. Once the comparison has been performed between different models (obtained at different periods of time), the output of the comparison can be output to a user (such as the manufacturer). This can be used to determine whether the manufacturing process has been improved, or, to the contrary, has been degraded.

Attention is now drawn to FIG. 20.

The process as described with reference to FIG. 2 (and in the other methods) adapts to any shape of the contour of the element, which includes curved portions. In particular, it is not required to know in advance the shape of the contour. In addition, the steps described with reference to FIG. 2 (and in the other methods) do not need to be modified for different shapes of the contour of the element, and the same approach can be used. This is illustrated with reference to operation 2000, which indicates that operations 200 to 230 can be performed, whatever the shape of the contour of the element, provided that the contour includes one or more curved portions. In particular, the shape of the contour is such that an average component of the contour includes one or more curved portions.

Generation of the model informative of the contour of the element is performed even if the shape of the contour of the element is not known in advance. According to this process, the corners of the design data are identified, and an initial model in which the corners are modelled by curved portions is generated. The curvature of the curved portions of the initial model can be set randomly. A fit is performed between each curved portion of the initial model and a corresponding curved portion of the contour. After this fit, the curved portions are connected by straight portions, thereby obtaining a model. Alternatively, one or more implicit functions modelling the initial model are determined. A fit between the implicit function(s) and at least part of the contour can be performed to generate the model.

As can be understood from these operations, the shape of the contour of the element do not need to be known in advance in order to generate the model which approximates the average position of the points of the contour.

In the detailed description, numerous specific details have been set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the aforementioned discussions, it is appreciated that throughout the specification discussions utilizing terms such as “determining”, “using”, “tracing”, “comparing”, “detecting”, “obtaining”, or the like, refer to the action(s) and/or process(es) of a computer (or equivalently one or more processing circuitries) that manipulate and/or transform data into other data, said data represented as physical, such as electronic, quantities and/or said data representing the physical objects.

The terms “computer” or “computer-based system” should be expansively construed to include any kind of hardware-based electronic device with a data processing circuitry (e.g., digital signal processor (DSP), a GPU, a TPU, a field programmable gate array (FPGA), an application specific integrated circuit (ASIC), microcontroller, microprocessor etc.), including, by way of non-limiting example, the computer-based system 103 of FIG. 1 and respective parts thereof disclosed in the present application. The data processing circuitry (designated also as processing circuitry) can comprise, for example, one or more processors operatively connected to computer memory, loaded with executable instructions for executing operations, as further described below. The data processing circuitry encompasses a single processor or multiple processors, which may be located in the same geographical zone, or may, at least partially, be located in different zones, and may be able to communicate together. The one or more processors can represent one or more general-purpose processing devices such as a microprocessor, a central processing unit, or the like. More particularly, a given processor may be one of: a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

The terms “non-transitory memory” and “non-transitory storage medium” used herein should be expansively construed to cover any volatile or non-volatile computer memory suitable to the presently disclosed subject matter. The terms should be taken to include a single medium or multiple media (e.g., a centralized or distributed database, and/or associated caches and servers) that store the one or more sets of instructions. The terms shall also be taken to include any medium that is capable of storing or encoding a set of instructions for execution by the computer and that cause the computer to perform any one or more of the methodologies of the present disclosure. The terms shall accordingly be taken to include, but not be limited to, a read only memory (“ROM”), random access memory (“RAM”), magnetic disk storage media, optical storage media, flash memory devices, etc.

It is to be noted that while the present disclosure refers to the processing circuitry 104 being configured to perform various functionalities and/or operations, the functionalities/operations can be performed by the one or more processors of the processing circuitry 104 in various ways. By way of example, the operations described hereinafter can be performed by a specific processor, or by a combination of processors. The operations described hereinafter can thus be performed by respective processors (or processor combinations) in the processing circuitry 104, while, optionally, at least some of these operations may be performed by the same processor. The present disclosure should not be limited to be construed as one single processor always performing all the operations.

The term “specimen” used in this specification should be expansively construed to cover any kind of wafer, masks, and other structures, combinations and/or parts thereof used for manufacturing semiconductor integrated circuits, magnetic heads, flat panel displays, and other semiconductor-fabricated articles.

The term “examination” used in this specification should be expansively construed to cover any kind of metrology-related operations, as well as operations related to detection and/or classification of defects in a specimen during its fabrication. Examination is provided by using non-destructive examination tools during or after manufacture of the specimen to be examined. By way of non-limiting example, the examination process can include runtime scanning (in a single or in multiple scans), sampling, reviewing, measuring, classifying and/or other operations provided with regard to the specimen or parts thereof using the same or different inspection tools. Likewise, examination can be provided prior to manufacture of the specimen to be examined, and can include, for example, generating an examination recipe(s) and/or other setup operations. It is noted that, unless specifically stated otherwise, the term “examination”, or its derivatives used in this specification, is not limited with respect to resolution or size of an inspection area. A variety of non-destructive examination tools includes, by way of non-limiting example, scanning electron microscopes, atomic force microscopes, optical inspection tools, etc.

The term “defect” used in this specification should be expansively construed to cover any kind of abnormality or undesirable feature/functionality present in a specimen.

The term “design data” used in the specification should be expansively construed to cover any data indicative of hierarchical physical design (layout) of a specimen. Design data can be provided by a respective designer and/or can be derived from the physical design (e.g. through complex simulation, simple geometric and Boolean operations, etc.). Design data can be provided in different formats such as, by way of non-limiting examples, GDSII format, OASIS format, etc. Design data can be presented in vector format, grayscale intensity image format, or otherwise.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately, or in any suitable sub-combination. In the detailed description, numerous specific details are set forth in order to provide a thorough understanding of the methods and apparatus.

In embodiments of the presently disclosed subject matter, fewer, more, and/or different stages than those shown in the methods of FIGS. 2, 7, 10, 12B, 13, 18A, 18B, 18D, 19 and 20 may be executed. In embodiments of the presently disclosed subject matter, one or more stages illustrated in the methods of FIGS. 2, 7, 10, 12B, 13, 18A, 18B, 18D, 19 and 20 may be executed in a different order, and/or one or more groups of stages may be executed simultaneously.

It is to be understood that the invention is not limited in its application to the details set forth in the description contained herein or illustrated in the drawings.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

What is claimed is

1. A system comprising one or more processing circuitries configured to:
obtain data D_{contour} informative of a contour of at least one element of a semiconductor specimen in an image of the specimen,
obtain design data informative of the at least one element, wherein the design data comprises a plurality of corners,
determine, in the design data, first areas, wherein each respective first area of the first areas comprises a respective corner of the plurality of corners, and
use the first areas and the data D_{contour} to determine a model which fits the contour.

2. The system of claim 1, configured to:
determine second areas corresponding to straight portions of the design data, and
use the first areas, the second areas, and the data D_{contour} to determine the model which fits the contour.

3. The system of claim 1, wherein the model fits an average component of the contour.

4. The system of claim 1, wherein the model is usable to perform at least one of:
(i) detecting a mismatch between the contour and the design data,
(ii) determining one or more metrology measurements, or
(iii) correcting a manufacturing process of the element.

5. The system of claim 1, configured to use the first areas to generate an initial model, in which each of the corner of the plurality of corners is represented by a curved portion.

6. The system of claim 5, wherein the initial model further comprises a plurality of straight portions, wherein the system is configured to fit the initial model to the contour, wherein, in said fit, the curved portions of the initial model remain curved, and the straight portions of the initial model remain straight.

7. The system of claim 5, configured to, for each given curved portion of the plurality of curved portions, fit said given curved portion with a corresponding curved portion of the contour, thereby obtaining a plurality of fitted curved portions.

8. The system of claim 5, configured to:
determine, in the contour, a plurality of third areas, informative of curved portions of the contour, and
fit each given curved portion of the initial model with a given part of the contour located in a given third area of the plurality of third areas.

9. The system of claim 5, configured to:
fit a piecewise polynomial function to the contour, determine curvature along at least part of the piecewise polynomial function, thereby enabling identification of a plurality of third areas informative of curved portions of the contour, and
fit each given curved portion of the plurality of curved portions of the initial model with a given part of the contour located in a given third area of the plurality of third areas, thereby enabling generating the model.

10. The system of claim 5, configured to:
for a straight component of the initial model, perform a fit between this given straight component and a plurality of points of the contour, wherein said fit models the given straight component using an implicit function.

11. The system of claim 5, configured to:
determine a pairing between respective points of a given curved portion of the plurality of curved portions and respective points of a corresponding curved portion of the contour, and
use said pairing to fit the given curved portion to the corresponding curved portion of the contour.

12. The system of claim 5, configured to:
divide the initial model into a plurality of components comprising one or more straight components and one or more curved components,
pair each given point of a plurality of points of the contour with a given component of the plurality of components,
fit a given straight component of the plurality of components, to points of the contour which have been paired with this given straight component, by using an implicit function, and
fit a given curved component of the plurality of components, to points of the contour which have been paired with this given curved component.

13. The system of claim 12, wherein fitting the given curved component of the plurality of components, to the points of the contour which have been paired with this given curved component, comprises:
pairing the points of the contour which have been paired with this given curved component with points of the given curved component, thereby obtaining a plurality of pairs of points, and
using the plurality of pairs of points to perform the fitting.

14. The system of claim 1, wherein the contour is modellable by a first component and a second component, wherein the second component has a higher frequency of variation than the first component, wherein the model fits the first component of the contour.

15. The system of claim 1, wherein the contour is modellable by a profile, wherein said profile is correctable in order to improve its match with the design data, wherein the model fits said correctable profile.

16. The system of claim 15, wherein the contour is modellable by an additional part which is non-correctable locally, wherein the system is operative to differentiate between the profile and said additional part.

17. The system of claim 1, configured to store the model using a format enabling curvilinear representation using Bezier and/or B-spline curves.

18. The system of claim 1, wherein at least one of (i) or (ii) is met:
(i) the system is operative to determine the model which fits the contour of the element without requiring prior knowledge on the shape of the contour;
(ii) the system is operative to determine the model which fits the contour whatever the contour's shape, wherein the contour comprises one or more curved portions.

19. A computer-implemented method comprising:
obtaining data D_{contour} informative of a contour of at least one element of a semiconductor specimen in an image of the specimen,
obtaining design data informative of the at least one element, wherein the design data comprises a plurality of corners,
determining, in the design data, first areas, wherein each respective first area of the first areas comprises a respective corner of the plurality of corners, and
using the first areas and the data D_{contour} to determine a model which fits the contour.

20. A non-transitory computer readable medium comprising instructions that, when executed by at least one or more processing circuitries, cause the at least one or more processing circuitries to perform:
obtaining data D_{contour} informative of a contour of at least one element of a semiconductor specimen in an image of the specimen,
obtaining design data informative of the at least one element, wherein the design data comprises a plurality of corners,
determining, in the design data, first areas, wherein each respective first area of the first areas comprises a respective corner of the plurality of corners, and using the first areas and the data D_{contour} to determine a model which fits the contour.
